(19) United States
(12) Patent Application Publication
(10) Pub. No.: US 2015/0093581 A1
(43) Pub. Date: Apr. 2, 2015

(54) TOUGHENED GLASS SUBSTRATE AND MANUFACTURING PROCESS THEREFOR

(71) Applicant: Nippon Electric Glass Co., Ltd., Shiga (JP)

(72) Inventors: Takashi MURATA, Shiga (JP); Takako TOJYO, Shiga (JP); Motokazu OGATA, Shiga (JP)

(21) Appl. No.: 14/560,785

(22) Filed: Dec. 4, 2014

Related U.S. Application Data
(63) Continuation-in-part of application No. PCT/JP2013/067951, filed on Jun. 21, 2013.

(30) Foreign Application Priority Data
Jun. 25, 2012 (JP) 2012-141920
Mar. 21, 2013 (JP) 2013-057722

(51) Int. Cl. C03C 21/00; C03C 3/085; G09F 9/00; C03C 4/18; C03B 17/06; C03C 3/083; C03C 3/087

(52) U.S. Cl. CPC C03C 21/002; C03C 3/083; C03C 3/085; C03C 3/087; C03C 4/18; C03B 17/064; G09F 9/00; C03C 2204/00
USPC 428/410; 501/11; 501/68; 501/69; 501/70; 65/30.14

(57) ABSTRACT

An object is to devise a tempered glass substrate that has high mechanical strength and hardly undergoes breakage even though having a large size. A tempered glass substrate has a compressive stress layer in a surface thereof, and includes 1 piece/cm³ or less of devitrified stones containing Zr.

### TECHNICAL FIELD

The present invention relates to a tempered glass substrate and a manufacturing method therefor, and more particularly, to a tempered glass substrate suitable for a cover glass for a cellular phone, a digital camera, a personal digital assistant (PDA), or a solar cell, or a substrate for a touch panel display, and a manufacturing method therefor.

### BACKGROUND ART

Devices such as a cellular phone, a digital camera, a PDA, a solar cell, and a touch panel display are widely used and show a tendency of further prevalence. In those applications, a chemically tempered glass substrate is used as a cover glass or a substrate.

Currently, there are studies on using the tempered glass substrate as a protective member for a display of a TV, a monitor, or the like.

The tempered glass substrate is required to, for example, (1) have a high mechanical strength, (2) have a low density and a light weight, (3) be able to be supplied at low cost in a large amount, (4) be excellent in bubble quality, (5) have a high light transmittance in a visible region, and (6) have a high Young's modulus so as not to bend easily when its surface is pushed with a pen, a finger, or the like. In particular, when the chemically tempered glass substrate is used as the protective member, the characteristic (1) is important (see Patent Literature 1 and Non Patent Literature 1).

### CITATION LIST

### Patent Literature

[PTL 1] JP 2006-83045 A

### Non Patent Literature

[NPL 1] Tetsuro Izumitani et al., “New glass and physical properties thereof,” First edition, Management System Laboratory. Co., Ltd., Aug. 20, 1984, p. 451-498

### SUMMARY OF INVENTION

### Technical Problem

For enhancing the mechanical strength of a tempered glass, there is a need to enhance ion exchange performance by increasing the content of Al₂O₃ in a glass composition. However, increasing the content of Al₂O₃ leads to an increased glass viscosity and a higher melting temperature. In melting and forming of such glass, a zirconia-based refractory or a zircon-based refractory has hitherto been used for a wall portion to be brought into contact with the glass.

However, in the case of producing a tempered glass substrate comprising a specific glass composition, using a zirconia-based refractory or a zircon-based refractory may lead to formation of a high-concentration Zr layer at an interface between the refractory and a molten glass, and in addition, stagnation of a molten glass material containing the high-concentration Zr layer in a low temperature region in the melting step to forming step, followed by deposition of devitrified stones containing Zr.

Further, when a higher compressive stress value and a greater depth of layer are employed with a view to enhancing the mechanical strength of a large-size tempered glass substrate, an internal tensile stress value tends to increase. In this case, when the devitrified stones are present in an internal tensile stress layer, the tempered glass substrate is liable to undergo breakage. The probability of such breakage becomes higher especially for a larger-size tempered glass substrate.

The present invention has been made in view of the above-mentioned circumstances, and a technical object of the present invention is to devise a tempered glass substrate that has high mechanical strength and hardly undergoes breakage even though having a large size, and a manufacturing method therefor.

### Solution to Problem

The inventors of the present invention have made various studies and have consequently found that the technical object can be achieved by controlling the number of devitrified stones containing Zr within a predetermined range in a tempered glass substrate. Thus, the finding is proposed as the present invention. That is, a tempered glass substrate of the present invention has a compressive stress layer in a surface thereof, and comprises 1 piece/cm³ or less of devitrified stones containing Zr. Herein, the “devitrified stones containing Zr” are determined as described below. Observation with a stereoscopic microscope is performed. When a devitrified stone of 1 μm or more is observed in an observation field, such devitrified stone is counted as the devitrified stone. An incidence of the devitrified stone per 1 cm³ is calculated based on the size of a glass substrate (tempered glass substrate) used for the measurement.

Second, it is preferred that the tempered glass substrate of the present invention have the compressive stress layer in a surface of a glass substrate formed by an overflow down-draw method. Herein, the “overflow down-draw method” refers to a method comprising causing a glass in a molten state to overflow from both sides of a trough-shaped structure, and subjecting the overflowing molten glasses to down-draw downward while the molten glasses are joined at the lower end of the trough-shaped structure, to thereby manufacture a glass substrate.

The overflow down-draw method has hitherto used a zirconia-based refractory or a zircon-based refractory as the trough-shaped structure. However, when a zirconia-based refractory or a zircon-based refractory is used as the trough-shaped structure, it becomes difficult to control the devitrified stones containing Zr to 1 piece/cm³ or less, and the content of Zr (ZrO₂) in a joining surface (confluent surface) is liable to increase. In this context, when a refractory comprising a high content of Al₂O₃ is used as the trough-shaped structure, the devitrified stones containing Zr can be reduced to the extent possible. In addition, the content of Zr (ZrO₂) in the joining surface is easily decreased. Further, the refractory comprising a high content of Al₂O₃ hardly deforms even after used for a long period of time and hardly allows for formation of devitrified stones other than the devitrified stones containing Zr.

The content of Al₂O₃ in the trough-shaped structure is preferably 10 mass % or more, more preferably 30 mass % or more, more preferably 50 mass % or more, more preferably 70 mass % or more, more preferably 90 mass % or more, particularly preferably 95 mass % or more. With this, Zr hardly elutes from the trough-shaped structure into the molten glass in the forming.

It is also preferred to use a refractory comprising a high content of Al₂O₃ as a melting brick of a melting furnace. This facilitates control of the devitrified stones containing Zr to 1 piece/cm³ or less. The content of Al₂O₃ in the melting brick of the melting furnace is preferably 10 mass % or more, more preferably 30 mass % or more, more preferably 50 mass % or more, more preferably 70 mass % or more, more preferably 90 mass % or more, particularly preferably 95 mass % or more. With this, Zr hardly elutes from the melting brick of the melting furnace into the molten glass in the melting.

Third, a tempered glass substrate of the present invention has a value of (a content of Zr in a center portion in a thickness direction)/(a content of Zr near a surface) of 3 or less. Herein, the value of “(a content of Zr in a center portion in a thickness direction)/(a content of Zr near a surface) ” refers to a value measured by, for example, SIMS, and is a value calculated as Aave/Bave, where Aave and Bave represent average values of the content of Zr in the center portion in the thickness direction, A, and the content of Zr near the surface, B, respectively, obtained through standardization to Si.

The center portion of a tempered glass substrate in the thickness direction comprises a tensile stress layer. When the devitrified stones are present in the center portion, the tempered glass substrate is liable to undergo breakage. In this context, when the value of (a content of Zr in a center portion in the thickness direction)/(a content of Zr near a surface) is controlled to 3 or less, the tempered glass substrate hardly undergoes breakage even when the internal tensile stress value is high.

Fourth, it is preferred that the tempered glass substrate of the present invention have a compressive stress layer formed by chemical treatment.

Fifth, it is preferred that the tempered glass substrate of the present invention have a compressive stress value in a surface of 300 MPa or more, a depth of layer of 10 μm or more, and an internal tensile stress value of 200 MPa or less. Herein, the “compressive stress value of the compressive stress layer” and the “depth of layer” refer to values calculated on the basis of the number of interference fringes observed when a sample is observed using a surface stress meter (for example, FSM-6000 manufactured by TOSHIBA CORPORATION) and intervals therebetween. The “internal tensile stress value” refers to a value calculated from the following mathematical equation.

Internal tensile stress value=(compressive stress valuexdepth of layer)/(substrate thickness-depth of layer×2)

Sixth, it is preferred that the tempered glass substrate of the present invention have an unpolished surface.

Seventh, it is preferred that the tempered glass substrate of the present invention comprise as a glass composition, in terms of mass %, 40 to 71% of SiO₂, 3 to 30% of Al₂O₃, 0 to 3.5% of Li₂O, 7 to 20% of Na₂O, and 0 to 15% of K₂O. The tempered glass substrate comprising such glass composition easily has the devitrified stones containing Zr deposited therein particularly when brought into contact with a zirconia-based refractory or a zircon-based refractory. However, in contrast, when the refractory comprising 10 mass % or more of Al₂O₃ is used, such tempered glass substrate hardly has troubles such as the devitrified stones containing Zr and bubble formation, and thus can be used for a long period of time. It should be noted that the tendency described above is remarkable with a higher content of Al₂O₃ in the glass composition.

Eighth, it is preferred that the tempered glass substrate of the present invention comprise as a glass composition, in terms of mass %, 40 to 71% of SiO₂, 7.5 to 30% of Al₂O₃, 0 to 2% of Li₂O, 10 to 19% of Na₂O, 0 to 15% of K₂O, 0 to 6% of MgO, 0 to 6% of CaO, 0 to 3% of SrO, 0 to 3% of BaO, and 0 to 8% of ZnO.

Ninth, the tempered glass substrate of the present invention is preferably used for a cover glass for a display.

Tenth, the tempered glass substrate of the present invention is preferably used for a cover glass for a solar cell.

Eleventh, a method of manufacturing a tempered glass substrate of the present invention comprises: a step (1) of blending glass raw materials; a step (2) of melting the blended raw materials so as to comprise 1 piece/cm³ or less of devitrified stones containing Zr to obtain a molten glass, followed by forming the molten glass into a sheet shape; and a step (3) of performing ion exchange treatment to form a compressive stress layer in a glass surface, to thereby obtain a tempered glass substrate.

Twelfth, it is preferred that, in the method of manufacturing a tempered glass substrate of the present invention, the step (1) comprise a step of blending the glass raw materials so as to comprise as a glass composition, in terms of mass %, 40 to 71% of SiO₂, 3 to 30% of Al₂O₃, 0 to 3.5% of Li₂O, 7 to 20% of Na₂O, and 0 to 15% of K₂O.

Thirteenth, it is preferred that, in the method of manufacturing a tempered glass substrate of the present invention, the step (2) comprise a step of forming the molten glass into a sheet shape by an overflow down-draw method.

Fourteenth, it is preferred that, in the method of manufacturing a tempered glass substrate of the present invention, the step (2) comprise a step of bringing the molten glass into contact with a refractory comprising 10 mass % or more of Al₂O₃.

Fifteenth, it is preferred that, in the method of manufacturing a tempered glass substrate of the present invention, the step (2) comprise a step of bringing the molten glass into contact with a refractory comprising 10 mass % or more of Al₂O₃ in the forming.

Sixteenth, it is preferred that, in the method of manufacturing a tempered glass substrate of the present invention, the step (2) comprise a step of bringing the molten glass into contact with a refractory comprising 10 mass % or more of Al₂O₃ in the forming, the molten glass having a viscosity of 10⁴ dPa·s or more and 10⁵ dPa·s or less.

Seventeenth, a method of manufacturing a tempered glass substrate of the present invention comprises: a step (1) of blending glass raw materials; a step (2)′ of melting the blended raw materials to obtain a molten glass, followed by bringing the molten glass into contact with a refractory comprising 10 mass % or more of Al₂O₃ to form the molten glass into a sheet shape; and a step (3) of performing ion exchange treatment to form a compressive stress layer in a glass surface, to thereby obtain a tempered glass substrate.

### BRIEF DESCRIPTION OF DRAWINGS

The patent or application file contains at least one drawing executed in color. Copies of this patent or patent application publication with color drawing(s) will be provided by the Office upon request and payment of the necessary fee.

FIG. 1 is an electron micrograph of Sample No. 1 in [Example 1] at an interface with a refractory.

FIG. 2 is an electron micrograph of Sample No. 2 in [Example 1] at an interface with a refractory.

FIG. 3 is an electron micrograph of Sample No. 3 in [Example 1] at an interface with a refractory.

FIG. 4 is an electron micrograph of Sample No. 4 in [Example 1] at an interface with a refractory.

FIG. 5 is a conceptual diagram illustrating measurement areas in SIMS in [Example 2].

FIG. 6 shows measurement results of Sample No. 2 in [Example 2] by SIMS.

FIG. 7 shows measurement results of Sample No. 4 in [Example 2] by SIMS.

### DESCRIPTION OF EMBODIMENTS

In a tempered glass substrate of the present invention, the number of devitrified stones containing Zr is 1 piece/cm³ or less, preferably less than 1 piece/cm³ , more preferably 0.5 piece/cm³ or less, more preferably 0.3 piece/cm³ or less, more preferably 0.1 piece/cm³ or less, more preferably 0.05 piece/cm³ or less, particularly preferably 0.01 piece/cm³ or less. When the number of the devitrified stones containing Zr is too large, an incidence of poor appearance of the tempered glass substrate Increase and the tempered glass substrate is liable to undergo breakage.

As a method of reducing the devitrified stones containing Zr, there are given: a method of employing a higher content of Al₂O₃ for a member to be brought into contact with a molten glass (such as a melting brick or a trough-shaped refractory) in manufacturing steps of the glass substrate; a method of using platinum, molybdenum, or the like for a member to be brought into contact with the molten glass; a method of employing a lower content of ZrO₂ in a glass composition; and the like.

The tempered glass substrate of the present invention has a compressive stress layer in its surface. As a method of forming the compressive stress layer in the surface, there are given a physical tempering method and a chemical tempering method. In the present invention, it is preferred to apply a chemical tempering method to the formation of the compressive stress layer. The chemical tempering method is a method involving introducing alkali ions each having a large ion radius into the glass surface by ion exchange treatment at a temperature equal to or lower than a strain point of the glass. When the chemical tempering method is used to form a compressive stress layer, desired mechanical strength can be obtained even in the case where the thickness of the glass substrate is small. In addition, even when a tempered glass is cut after the formation of the compressive stress layer, the tempered glass does not easily break unlike a tempered glass manufactured by applying a physical tempering method such as an air cooling tempering method.

The conditions of the ion exchange treatment are not particularly limited and may be determined in consideration of viscosity properties of the glass and the like. Particularly when ion exchange of K ions in a KNO₃ molten salt with Na components in the glass substrate is performed, it is possible to form the compressive stress layer efficiently in the surface of the glass substrate.

In the tempered glass substrate of the present invention, a compressive stress value of the compressive stress layer is preferably 600 MPa or more, more preferably 800 MPa or more, more preferably 1,000 MPa or more, more preferably 1,200 MPa or more, particularly preferably 1,300 MPa or more. A larger compressive stress brings about higher mechanical strength of the tempered glass substrate. Meanwhile, when an excessively high compressive stress is formed in the surface, microcracks may arise in the surface, which may contrarily end up lower mechanical strength of the tempered glass substrate. In addition, there is a risk in that an internal tensile stress of the tempered glass substrate may increase excessively. Accordingly, the compressive stress value is preferably 2,500 MPa or less. It should be noted that the compressive stress value may be increased by increasing the content of Al₂O₃, TiO₂, ZrO₂, MgO, ZnO, or SnO₂ or decreasing the content of SrO or BaO. Further, the compressive stress value may be increased by shortening a time necessary for ion exchange or decreasing the temperature of an ion exchange solution.

A depth of layer is preferably 10 μm or more, more preferably 15 μm or more, more preferably 20 μm or more, particularly preferably 30 μm or more. When the depth of layer is larger, the tempered glass substrate is less liable to break even when the tempered glass has a deep flaw. On the contrary, there is a risk in that cutting the tempered glass substrate becomes difficult, or the internal tensile stress increases excessively, resulting in breakage of the tempered glass substrate. Accordingly, the depth of layer is preferably 100 μm or less, more preferably 80 μm or less, particularly preferably 60 μm or less. It should be noted that the depth of layer may be increased by increasing the content of K₂O, P₂O₅, TiO₂, or ZrO₂ or decreasing the content of SrO or BaO. Further, the depth of layer may be increased by lengthening a time necessary for ion exchange or increasing the temperature of an ion exchange solution.

The internal tensile stress value is preferably 200 MPa or less, more preferably 150 MPa or less, more preferably 100 MPa or less, more preferably 60 MPa or less, particularly preferably 50 MPa or less. When the internal tensile stress value is smaller, the tempered glass substrate is less liable to undergo breakage owing to internal defects. In addition, the tempered glass substrate is easily cut stably. Further, it is possible to reduce a dimensional change in the cutting. However, when the internal tensile stress value is excessively small, the compressive stress value in the surface or the depth of layer decreases. Accordingly, the internal tensile stress value is preferably 1 MPa or more, more preferably 10 MPa or more, particularly preferably 15 MPa or more.

In the tempered glass substrate of the present invention, the compressive stress layer is preferably formed in a surface of a glass substrate formed by an overflow down-draw method. By forming a glass substrate by an overflow down-draw method, a glass substrate having satisfactory surface quality can be manufactured in an unpolished state. This is because, in an overflow down-draw method, the surface that is to serve as the surface of the glass substrate is formed in a state of a free surface without being brought into contact with the surface of a trough-shaped refractory, which allows for forming of a glass substrate having satisfactory surface quality in an unpolished state. It should be noted that a glass substrate can be formed by an overflow down-draw method when a liquidus temperature is 1,200° C. or less and a liquidus viscosity is 10^{4.0} dPa·s or more.

It should be noted that, in the case where high surface quality is not required, a forming method other than the overflow down-draw method may be adopted. For example, forming methods such as a down draw method (such as a slot down method or a re-draw method), a float method, a roll out method, and a press method may be adopted.

In the tempered glass substrate of the present invention, the value of (a content of Zr in a center portion in the thickness direction)/(a content of Zr near a surface) is preferably 3 or less, more preferably 2.5 or less, more preferably 2 or less, more preferably 1.5 or less, more preferably 1.3 or less, more preferably 1.2 or less, particularly preferably 1 or less. When this value is too large, the tempered glass substrate is liable to undergo breakage owing to the internal tensile stress. Similarly, the value of (a content of ZrO₂ in a center portion in the thickness direction)/(a content of ZrO₂ near a surface) is preferably 3 or less, more preferably 2.5 or less, more preferably 2 or less, more preferably 1.5 or less, more preferably 1.3 or less, more preferably 1.2 or less, particularly preferably 1 or less.

The tempered glass substrate of the present invention preferably has an unpolished surface, and the unpolished surface has an average surface roughness (Ra) of preferably 10 Å or less, more preferably 5 Å or less, more preferably 4 Å or less, more preferably 3 Å or less, particularly preferably 2 Å or less. It should be noted that the average surface roughness (Ra) may be measured by a method in conformity with SEMI D7-94 “FPD Glass Substrate Surface Roughness Measurement Method.” A glass substrate originally has extremely high theoretical strength, but often breaks even under a stress far lower than the theoretical strength. This is because a small flaw called a Griffith flaw is generated in the surface of the glass in a step after forming, such as a polishing step. Thus, when the surface of the glass is left unpolished, the original mechanical strength of the glass is not impaired, and the tempered glass substrate is less liable to break. In addition, when the surface of the glass is left unpolished, a polishing step can be omitted, and hence the manufacturing cost of the glass substrate can be reduced. When the entire effective surfaces in the tempered glass substrate of the present invention are left unpolished, the tempered glass substrate is still less liable to undergo breakage. In addition, in order to prevent a situation in which breakage occurs from a cut surface of the tempered glass substrate, the cut surface may be subjected to chamfering processing, etching treatment, or the like. It should be noted that in order to obtain the unpolished surface, it is recommended to form the glass substrate by an overflow down-draw method.

The reasons why the content of each component is limited in the tempered glass substrate of the present invention are described below. It should be noted that the expression “%” means “mass %” in the description of the content of each component.

SiO₂ is a component that forms a network of a glass. The content of SiO₂ is from 40 to 71%, preferably from 40 to 63%, more preferably from 45 to 63%, more preferably from 50 to 59%, particularly preferably from 55 to 58.5%. When the content of SiO₂ is too large, it becomes difficult to melt and form the glass, and the thermal expansion coefficient becomes too low, with the result that it becomes difficult to match the thermal expansion coefficient with those of peripheral materials. On the other hand, when the content of SiO₂ is too small, vitrification does not occur easily. Further, the thermal expansion coefficient becomes too high, and thermal shock resistance of the glass is liable to lower.

Al₂O₃ is a component that enhances ion exchange performance, and has also an effect of increasing a strain point and a Young's modulus. The content of Al₂O₃ is preferably from 3 to 30%. When the content of Al₂O₃ is too large, a devitrified crystal is liable to be deposited in the glass and it becomes difficult to form the glass by an overflow down-draw method. In particular, when the glass substrate is formed by an overflow down-draw method through use of a trough-shaped structure comprising a high content of Al₂O₃, a devitrified crystal of spinel is liable to be deposited at an interface with the trough-shaped structure comprising a high content of Al₂O₃. Further, the thermal expansion coefficient becomes too low, with the result that it becomes difficult to match the thermal expansion coefficient with those of peripheral materials. In addition, the viscosity at high temperature rises, and the meltability is liable to lower. When the content of Al₂O₃ is too small, sufficient ion exchange performance is not exhibited in some cases. From the above-mentioned viewpoints, the upper limit of the range of the content of Al₂O₃ is preferably 25% or less, more preferably 22% or less, particularly preferably 21% or less, and the lower limit thereof is preferably 7.5% or more, more preferably 8.5% or more, more preferably 9% or more, more preferably 10% or more, more preferably 12% or more, more preferably 13% or more, more preferably 14% or more, more preferably 16% or more, more preferably 18% or more, more preferably 19% or more, particularly preferably 20% or more.

Li₂O is an ion exchange component, and is also a component that lowers the viscosity at high temperature to increase the meltability and the formability. Further, Li₂O is a component that increases the Young's modulus. Further, Li₂O has a high effect of increasing the compressive stress value among alkali metal oxides. However, when the content of Li₂O is too large, the liquidus viscosity lowers and the glass is liable to be devitrified. Further, the thermal expansion coefficient becomes too high, and the thermal shock resistance lowers, with the result that it becomes difficult to match the thermal expansion coefficient with those of peripheral materials. Further, when the viscosity at low temperature excessively lowers and stress relaxation easily occurs, the compressive stress value may lower contrarily. Therefore, the content of Li₂O is from 0 to 3.5%, preferably from 0 to 2%, more preferably from 0 to 1%, more preferably from 0 to 0.5%, particularly preferably from 0 to 0.1%. It is most preferred that the content of Li₂O be substantially zero, that is, be limited to less than 0.01%. It should be noted that when Li₂O is added, the content of Li₂O is preferably 0.001% or more, particularly preferably 0.01% or more.

Na₂O is an ion exchange component, and is also a component that lowers the viscosity at high temperature to increase the meltability and the formability. Further, Na₂O is also a component that improves the devitrification resistance. The upper limit range of the content of Na₂O is preferably 20% or less, preferably 19% or less, more preferably from 17% or less, more preferably 15% or less, more preferably 14% or less, particularly preferably 13.5% or less, and the lower limit range of the content of Na₂O is preferably 7% or more, more preferably 8% or more, more preferably 10% or more, particularly preferably 12% or more. When the content of Na₂O is too large, the thermal expansion coefficient becomes too high, and the thermal shock resistance lowers, with the result that it becomes difficult to match the thermal expansion coefficient with those of peripheral materials. Further, there is a tendency that the strain point excessively lowers, and the glass composition loses its component balance, with the result that the devitrification resistance lowers contrarily. On the other hand, when the content of Na₂O is too small, the meltability lowers, the thermal expansion coefficient becomes too low, and the ion exchange performance is liable to lower.

K₂O is a component that has an effect of promoting ion exchange, and has a high effect of increasing a depth of layer among alkali metal oxides. Further, K₂O is a component that lowers the viscosity at high temperature to increase the meltability and the formability. K₂O is also a component that improves the devitrification resistance. The content of K₂O is preferably from 0 to 15%. When the content of K₂O is too large, the thermal expansion coefficient becomes high, and the thermal shock resistance lowers, with the result that it becomes difficult to match the thermal expansion coefficient with those of peripheral materials. Further, there is a tendency that the strain point excessively lowers, and the glass composition loses its component balance, with the result that the devitrification resistance lowers contrarily. Thus, the upper limit range of the content of K₂O is preferably 12% or less, more preferably 10% or less, more preferably 8% or less, more preferably 6% or less, more preferably 5% or less, more preferably 4% or less, more preferably 3% or less, more preferably 2% or less, particularly preferably less than 2%.

When the total content of alkali metal oxides R₂O (R represents one or more kinds selected from Li, Na, and K) is too large, the glass is liable to be devitrified. In addition, the thermal expansion coefficient becomes too high, and the thermal shock resistance lowers, with the result that it becomes difficult to match the thermal expansion coefficient with those of peripheral materials. Further, when the total content of alkali metal oxides R₂O is too large, the strain point excessively lowers, and a high compressive stress value is not obtained in some cases. Further, the viscosity around the liquidus temperature lowers, and it becomes difficult to secure a high liquidus viscosity in some cases. Thus, the total amount of R₂O is preferably 22% or less, more preferably 20% or less, particularly preferably 19% or less. On the other hand, when the total amount of R₂O is too small, the ion exchange performance or the meltability may lower in some cases. Thus, the total amount of R₂O is preferably 8% or more, more preferably 10% or more, more preferably 13% or more, particularly preferably 15% or more.

Further, the value of (Na₂O+K₂O) /Al₂O₃ is preferably regulated to from 0.7 to 2, from 0.8 to 1.6, from 0.9 to 1.6, or from 1 to 1.6, in particular, from 1.2 to 1.6. When the value increases, the viscosity at low temperature is liable to lower excessively to lower the ion exchange performance, the Young's modulus is liable to lower, and the thermal expansion coefficient is liable to increase excessively to lower the thermal shock resistance. When the value increases, the glass composition loses its balance, with the result that the glass is liable to be devitrified. On the other hand, when the value decreases, the meltability and the devitrification resistance are liable to lower.

A molar ratio (Al₂O₃+MgO)/Na₂O is preferably 1.1 or less, more preferably 1.08 or less, more preferably 1.07 or less, more preferably 1.06 or less, more preferably 1.04 or less, particularly preferably 1.02 or less. With this, generation of the devitrified stones is easily suppressed at an interface with the trough-shaped structure comprising a high content of Al₂O₃. Specifically, generation of the devitrified stones is easily suppressed at an interface with the trough-shaped structure comprising a high content of Al₂O₃ when the glass is retained at a viscosity of 10^{4.5} dPa·s (a viscosity in the forming) for 48 hours.

A mass ratio K₂O/Na₂O preferably falls within the range of from 0 to 2. The compressive stress value and the depth of layer can be changed by changing the mass ratio K₂O/Na₂O. When it is desired to set the compressive stress value high, the mass ratio is preferably adjusted to from 0 to 0.3 or from 0 to 0.2, in particular, from 0 to 0.1. Meanwhile, when it is desired to additionally increase the depth of layer or form a deep compressive stress layer in a short period of time, the mass ratio is preferably adjusted to from 0.3 to 2, from 0.5 to 2, from 1 to 2, or from 1.2 to 2, in particular, from 1.5 to 2. In this case, the reason why the upper limit of the mass ratio is set to 2 is as follows: when the value is more than 2, the glass composition loses its balance, with the result that the glass is liable to be devitrified.

For example, alkaline earth metal oxides R′O (R′ represents one or more kinds selected from Mg, Ca, Sr, and Ba) are components that may be added for various purposes. However, when the total content of R′O is high, the density and the thermal expansion coefficient become high, and the devitrification resistance lowers. In addition, the ion exchange performance tends to lower. Therefore, the total content of R′O is preferably from 0 to 9.9%, more preferably from 0 to 8%, more preferably from 0 to 6%, particularly preferably from 0 to 5%.

MgO is a component that lowers the viscosity at high temperature to increase the meltability and the formability, or to increase the strain point and the Young's modulus, and has a high effect of improving the ion exchange performance among alkaline earth metal oxides. The content of MgO is preferably from 0 to 6%. However, when the content of MgO is high, the density and the thermal expansion coefficient increase, and the glass is liable to be devitrified. In particular, when the glass substrate is formed by an overflow down-draw method through use of a trough-shaped structure comprising a high content of Al₂O₃, a devitrified crystal of spinel is easily deposited at an interface with the trough-shaped structure comprising a high content of Al₂O₃. Accordingly, the content of Al₂O₃ is preferably 4% or less, more preferably 3% or less, more preferably 2.5% or less, more preferably 2% or less, particularly preferably 1.5% or less. It should be noted that, in the case of adding MgO, the content of MgO is preferably 0.01% or more, more preferably 0.1% or more, more preferably 0 .5% or more, particularly preferably 1% or more.

CaO is a component that lowers the viscosity at high temperature to increase the meltability and the formability, or to increase the strain point and the Young's modulus, and has a high effect of improving the ion exchange performance among alkaline earth metal oxides. The content of CaO is preferably from 0 to 6%. However, when the content of CaO is high, the density and the thermal expansion coefficient increase, and the glass is liable to be devitrified. In addition, the ion exchange performance lowers in some cases. Therefore, the content of CaO is preferably 4% or less, particularly preferably 3% or less.

SrO and BaO are components that lower the viscosity at high temperature to increase the meltability and the formability, or to increase the strain point and the Young's modulus. The content of each of SrO and BaO is preferably from 0 to 3%. When the content of each of SrO and BaO is high, the ion exchange performance tends to lower. Further, the density and the thermal expansion coefficient increase, and the glass is liable to be devitrified. The content of SrO is preferably 2% or less, more preferably 1.5% or less, more preferably 1% or less, more preferably 0.5% or less, more preferably 0.2% or less, particularly preferably 0.1% or less. In addition, the content of BaO is preferably 2.5% or less, more preferably 2% or less, more preferably 1% or less, more preferably 0.8% or less, more preferably 0.5% or less, more preferably 0.2% or less, particularly preferably 0.1% or less.

ZnO is a component that enhances the ion exchange performance, and has a high effect of increasing the compressive stress value, in particular. Further, ZnO is a component that has an effect of reducing the viscosity at high temperature without reducing the viscosity at low temperature. The content of ZnO is preferably from 0 to 8%. However, when the content of ZnO is high, the glass undergoes phase separation, the devitrification resistance lowers, and the density increases. Thus, the content of ZnO is preferably 6% or less, more preferably 4% or less, particularly preferably 3% or less.

The ion exchange performance can be more effectively enhanced by controlling the total content of SrO+BaO to from 0 to 5%. That is, SrO and BaO each have an action of inhibiting an ion exchange reaction as described above, and hence the incorporation of large amounts of these components is disadvantageous for increasing the mechanical strength of the tempered glass. The total content of SrO+BaO falls within the range of preferably from 0 to 3%, more preferably from 0 to 2.5%, more preferably from 0 to 2%, more preferably from 0 to 1%, more preferably from 0 to 0.2%, particularly preferably from 0 to 0.1%.

When a value obtained by dividing the total content of R′O by the total content of R₂O increases, there appears a tendency that the devitrification resistance lowers. Thus, the value of R′O/R₂O in terms of a mass ratio is controlled to preferably 0.5 or less, more preferably 0.4 or less, particularly preferably 0.3 or less.

SnO₂ has an effect of enhancing the ion exchange performance, in particular, the compressive stress value. Thus, the content of SnO₂ is preferably from 0.01 to 3%, more preferably from 0.01 to 1.5%, particularly preferably from 0.1 to 1%. When the content of SnO₂ is high, devitrification due to SnO₂ tends to occur or the glass tends to be easily colored.

ZrO₂ has effects of remarkably improving the ion exchange performance and simultaneously, increasing the Young's modulus and the strain point, and lowering the viscosity at high temperature. Further, ZrO₂ has an effect of increasing the viscosity around the liquidus viscosity. Therefore, by inclusion of a given amount of ZrO₂, the ion exchange performance and the liquidus viscosity can be improved simultaneously. However, when the content of ZrO₂ is too large, the devitrification resistance remarkably lowers in some cases. Thus, the content of ZrO₂ is preferably from 0 to 10%, more preferably from 0.001 to 10%, more preferably from 0.1 to 9%, more preferably from 0.5 to 7%, more preferably from 1 to 5%, particularly preferably from 2.5 to 5%. It should be noted that, in the case where reduction of the devitrified stones containing Zr to the extent possible is required, the content of ZrO₂ is preferably 1% or less, more preferably 0.5% or less, more preferably 0.1% or less, particularly preferably less than 0.1%.

B₂O₃ has effects of lowering the liquidus temperature, the viscosity at high temperature, and the density and has an effect of improving the ion exchange performance, in particular, the compressive stress value, and hence may be comprised together with the above-mentioned components. However, when the content of B₂O₃ is too large, there are risks in that weathering occurs on the surface by ion exchange treatment, the water resistance lowers, and the liquidus viscosity lowers. Further, the depth of layer tends to lower. Therefore, the content of B₂O₃ is preferably from 0 to 6%, more preferably from 0 to 4%, particularly preferably from 0 to 3%.

TiO₂ is a component that has an effect of improving the ion exchange performance. Further, TiO₂ has an effect of lowering the viscosity at high temperature. However, when the content of TiO₂ is too large, the glass is colored, the devitrification resistance lowers, and the density increases. Particularly in the case of using the glass as a cover glass for a display, if the content of TiO₂ is high, the transmittance is liable to change when the melting atmosphere or raw materials are altered. Therefore, in a process for bonding a glass substrate to a device by utilizing light with a UV-curable resin or the like, ultraviolet irradiation conditions are liable to vary and stable production becomes difficult. Therefore, the content of TiO₂ is preferably 10% or less, more preferably 8% or less, more preferably 6% or less, more preferably 5% or less, more preferably 4% or less, more preferably 2% or less, more preferably 0.7% or less, more preferably 0.5% or less, more preferably 0.1% or less, particularly preferably 0.01% or less.

In the present invention, ZrO₂ and TiO₂ are preferably comprised within the above-mentioned ranges from the viewpoint of improving the ion exchange performance, and reagents may be used as a TiO₂ source and a ZrO₂ source, or ZrO₂ and TiO₂ to be comprised may derive from impurities comprised in raw materials or the like.

From the viewpoint of achieving both the devitrification resistance and the ion exchange performance, the content of Al₂O₃+ZrO₂ is preferably specified as described below. When the content of Al₂O₃+ZrO₂ is preferably more than 12%, more preferably 13% or more, more preferably 15% or more, more preferably 17% or more, more preferably 18% or more, particularly preferably 19% or more, the ion exchange performance can be more effectively enhanced. However, when the content of Al₂O₃+ZrO₂ is excessively high, the devitrification resistance lowers excessively. Thus, the content of Al₂O₃+ZrO₂ is preferably 28% or less, more preferably 25% or less, more preferably 23% or less, more preferably 22% or less, particularly preferably 21% or less.

P₂O₅ is a component that enhances the ion exchange performance, and in particular, has a high effect of increasing a depth of layer. Thus, the content of P₂O₅ is preferably from 0 to 8%. However, when the content of P₂O₅ is high, the glass manifests phase separation, and the water resistance and the devitrification resistance are liable to lower. Thus, the content of P₂O₅ is preferably 5% or less, more preferably 4% or less, more preferably 3% or less, particularly preferably 2% or less.

As the fining agent, one kind or two or more kinds selected from the group consisting of As₂O₃, Sb₂O₃, CeO₂, F, SO₃, and Cl may be added in an amount of from 0.001 to 3%. It should be noted that the use of As₂O₃ and Sb₂O₃ is preferably avoided as much as possible with a view to environmental friendliness. Thus, the content of each of As₂O₃ and Sb₂O₃ is preferably less than 0.1%, particularly preferably less than 0.01%. That is, it is preferred that the content of each of As₂O₃ and Sb₂O₃ be substantially zero. CeO₂ is a component that decreases the transmittance. Thus, the content of CeO₂ is preferably less than 0.1%, particularly preferably less than 0.01%.

That is, it is preferred that the content of CeO₂ be substantially zero. F may decrease the viscosity at low temperature and the compressive stress value. Thus, the content of F is preferably less than 0.1%, particularly preferably less than 0.01%. That is, it is preferred that the content of F be substantially zero. Accordingly, preferred fining agents are SO₃ and Cl, and one or both of SO₃ and Cl are added in an amount of preferably from 0.001 to 3%, more preferably from 0.001 to 1%, more preferably from 0.01 to 0.5%, particularly preferably from 0.05 to 0.4%.

Rare earth oxides such as Nd₂O₅ and La₂O₃ are components that increase the Young's modulus. However, the cost of the raw material itself is high, and when the rare earth oxides are contained in large amounts, the devitrification resistance lowers. Therefore, the content of the rare earth oxides is preferably 3% or less, more preferably 2% or less, more preferably 1% or less, more preferably 0.5% or less, particularly preferably 0.1% or less.

Transition metal elements such as Co and Ni, which cause intense coloration of a glass, tend to lower the transmittance. In particular, in the case of using the transition metal elements in a display, when the content of the transition metal elements is high, the visibility of the display is liable to lower. Thus, the content of the transition metal elements is preferably 0.5% or less, more preferably 0.1% or less, particularly preferably 0.05%. It is desired that the use amount of raw materials or cullet be adjusted so as to achieve the content.

The content of oxides of substances such as Pb and Bi is preferably controlled to less than 0.1% with a view to environmental friendliness.

In the tempered glass substrate of the present invention, the suitable content range of each component can be appropriately selected to attain a preferred glass composition range. Specific examples thereof are shown below.

(1) Glass composition comprising, in terms of mass %, 40 to 71% of SiO₂, 7.5 to 30% of Al₂O₃, 0 to 2% of Li₂O, 10 to 19% of Na₂O, 0 to 15% of K₂O, 0 to 6% of MgO, 0 to 6% of CaO, 0 to 3% of SrO, 0 to 3% of BaO, 0 to 8% of ZnO, and 0.01 to 3% of SnO₂.

(2) Glass composition comprising, in terms of mass %, 40 to 71% of SiO₂, 7.5 to 30% of Al₂O₃, 0 to 2% of Li₂O, 10 to 19% of Na₂O, 0 to 15% of K₂O, 0 to 6% of MgO, 0 to 6% of CaO, 0 to 3% of SrO, 0 to 3% of BaO, 0 to 8% of ZnO, 0.01 to 3% of SnO₂, and 0.001 to 10% of ZrO₂.

(3) Glass composition comprising, in terms of mass %, 40 to 71% of SiO₂, 8.5 to 30% of Al₂O₃, 0 to 1% of Li₂O, 10 to 19% of Na₂O, 0 to 10% of K₂O, 0 to 6% of MgO, 0 to 6% of CaO, 0 to 3% of SrO, 0 to 3% of BaO, 0 to 8% of ZnO, and 0.01 to 3% of SnO₂.

(4) Glass composition comprising, in terms of mass %, 40 to 71% of SiO₂, 8.5 to 30% of Al₂O₃, 0 to 1% of Li₂O, 10 to 19% of Na₂O, 0 to 10% of K₂O, 0 to 6% of MgO, 0 to 6% of CaO, 0 to 3% of SrO, 0 to 3% of BaO, 0 to 8% of ZnO, 0.01 to 3% of SnO₂, and 0.001 to 10% of ZrO₂.

(5) Glass composition comprising, in terms of mass %, 40 to 71% of SiO₂, 9 to 25% of Al₂O₃, 0 to 6% of B₂O₃, 0 to 2% of Li₂O, 10 to 19% of Na₂O, 0 to 15% of K₂O, 0 to 6% of MgO, 0 to 6% of CaO, 0 to 3% of SrO, 0 to 3% of BaO, 0 to 6% of ZnO, 0.1 to 1% of SnO₂, and 0.001 to 10% of ZrO₂, and being substantially free of As₂O₃ and Sb₂O₃.

(6) Glass composition comprising, in terms of mass %, 40 to 71% of SiO₂, 9 to 23% of Al₂O₃, 0 to 4% of B₂O₃, 0 to 2% of Li₂O, 11 to 17% of Na₂O, 0 to 6% of K₂O, 0 to 6% of MgO, 0 to 6% of CaO, 0 to 3% of SrO, 0 to 3% of BaO, 0 to 6% of ZnO, 0.1 to 1% of SnO₂, and 0.001 to 10% of ZrO₂, and being substantially free of As₂O₃ and Sb₂O₃.

(7) Glass composition comprising, in terms of mass %, 40 to 63% of SiO₂, 9 to 22% of Al₂O₃, 0 to 3% of B₂O₃, 0 to 0.1% of Li₂O, 10 to 17% of Na₂O, 0 to 7% of K₂O, 0 to 5% of MgO, 0 to 4% of CaO, 0 to 3% of SrO+BaO, and 0.01 to 2% of SnO₂, being substantially free of As₂O₃ and Sb₂O₃, and having a value of (Na₂O+K₂O)/Al₂O₃ of from 0.9 to 1.6 and a value of K₂O/Na₂O of from 0 to 0.4 in terms of a mass ratio.

(8) Glass composition comprising, in terms of mass %, 40 to 71% of SiO₂, 3 to 30% of Al₂O₃, 0 to 2% of Li₂O, 10 to 20% of Na₂O, 0 to 9% of K₂O, 0 to 5% of MgO, 0 to 0.5% of TiO₂, and 0.001 to 3% of SnO₂.

(9) Glass composition comprising, in terms of mass %, 40 to 71% of SiO₂, 8 to 30% of Al₂O₃, 0 to 2% of Li₂O, 10 to 20% of Na₂O, 0 to 9% of K₂O, 0 to 5% of MgO, 0 to 0.5% of TiO₂, and 0.001 to 3% of SnO₂, and being substantially free of As₂O₃ and Sb₂O₃.

(10) Glass composition comprising, in terms of mass %, 40 to 65% of SiO₂, 8.5 to 30% of Al₂O₃, 0 to 1% of Li₂O, 10 to 20% of Na₂O, 0 to 9% of K₂O, 0 to 5% of MgO, 0 to 0.5% of TiO₂, and 0.01 to 3% of SnO₂, having a value of (Na₂O+K₂O)/Al₂O₃ of from 0.7 to 2 in terms of a mass ratio, and being substantially free of As₂O₃, Sb₂O₃, and F.

(11) Glass composition comprising, in terms of mass %, 40 to 65% of SiO₂, 8.5 to 30% of Al₂O₃, 0 to 1% of Li₂O, 10 to 20% of Na₂O, 0 to 9% of K₂O, 0 to 5% of MgO, 0 to 0.5% of TiO₂, 0.01 to 3% of SnO₂, and 0 to 8% of MgO+CaO+SrO+BaO, having a value of (Na₂O+K₂O) /Al₂O₃ of from 0.9 to 1.7 in terms of amass ratio, and being substantially free of As₂O₃, Sb₂O₃, and F.

(12) Glass composition comprising, in terms of mass %, 40 to 63% of SiO₂, 9 to 25% of Al₂O₃, 0 to 3% of B₂O₃, 0 to 1% of Li₂O, 10 to 20% of Na₂O, 0 to 9% of K₂O, 0 to 5% of MgO, 0 to 0.1% of TiO₂, 0.01 to 3% of SnO₂, 0.001 to 10% of ZrO₂, and 0 to 8% of MgO+CaO+SrO+BaO, having a value of (Na₂O+K₂O)/Al₂O₃ of from 1.2 to 1.6 in terms of a mass ratio, and being substantially free of As₂O₃, Sb₂O₃, and F.

(13) Glass composition comprising, in terms of mass %, 40 to 63% of SiO₂, 9 to 22% of Al₂O₃, 0 to 3% of B₂O₃, 0 to 1% of Li₂O, 10 to 20% of Na₂O, 0 to 9% of K₂O, 0 to 5% of MgO, 0 to 0.1% of TiO₂, 0.01 to 3% of SnO₂, 0.1 to 8% of ZrO₂, and 0 to 8% of MgO+CaO+SrO+BaO, having a value of (Na₂O+K₂O)/Al₂O₃ of from 1.2 to 1.6 in terms of a mass ratio, and being substantially free of As₂O₃, Sb₂O₃, and F.

(14) Glass composition comprising, in terms of mass %, 40 to 59% of SiO₂, 10 to 21% of Al₂O₃, 0 to 3% of B₂O₃, 0 to 0.1% of Li₂O, 10 to 20% of Na₂O, 0 to 7% of K₂O, 0 to 5% of MgO, 0 to 0.1% of TiO₂, 0.01 to 3% of SnO₂, 1 to 8% of ZrO₂, and 0 to 8% of MgO+CaO+SrO+BaO, having a value of (Na₂O+K₂O) /Al₂O₃ of from 1.2 to 1.6 in terms of a mass ratio, and being substantially free of As₂O₃, Sb₂O₃ and F.

The tempered glass substrate of the present invention has a thickness of preferably 3.0 mm or less, more preferably 1.5 mm or less, more preferably 0.7 mm or less, more preferably 0.5 mm or less, more preferably 0.4 mm or less, particularly preferably 0.3 mm or less. A smaller thickness enables weight saving of the tempered glass substrate. In addition, the tempered glass substrate of the present invention has an advantage of less breakage even in the case of having a smaller thickness. It should be noted that, when a molten glass is formed by an overflow down-draw method, thinning and smoothing of the glass substrate can be achieved without polishing or etching.

The tempered glass substrate of the present invention has a density of preferably 2.8 g/cm³ or less, more preferably 2.7 g/cm³ or less, particularly preferably 2.6 g/cm³ or less. A lower density enables weight saving of the tempered glass substrate. Herein, the “density” can be measured by, for example, a well-known Archimedes method. It should be noted that the density may be decreased by increasing the content of SiO₂, P₂O₅, or B₂O₃ or decreasing the content of an alkali metal oxide, an alkaline earth metal oxide, ZnO, ZrO₂, or TiO₂.

The tempered glass substrate of the present invention has a strain point of preferably 540° C. or more, more preferably 550° C. or more, particularly preferably 560° C. or more. Herein, the “strain point” refers to a value obtained through measurement based on a method of ASTM C336. A higher strain point brings about higher heat resistance, which leads to less thermal shrinkage of the tempered glass substrate even when the tempered glass substrate is subjected to heat treatment. In addition, the compressive stress layer is less liable to disappear. Further, when the strain point is high, stress relaxation hardly occurs in the ion exchange treatment, which allows for a high compressive stress value. It should be noted that the strain point may be increased by decreasing the content of an alkali metal oxide or increasing the content of an alkali earth metal oxide, Al₂O₃, ZrO₂, or P₂O₅.

The tempered glass substrate of the present invention has a temperature at 10^{2.5} dPa·s of preferably 1,650° C. or less, more preferably 1,500° C. or less, more preferably 1,450° C. or less, more preferably 1,430° C. or less, more preferably 1,420° C. or less, particularly preferably 1,400° C. or less. Herein, the “temperature at 10^{2.5} dPa·s” refers to a value obtained through measurement by a platinum sphere pull up method. The temperature at a viscosity at high temperature 10^{2.5} dPa·s corresponds to a melting temperature of glass, and as the temperature at 10^{2.5} dPa·s becomes lower, melting at lower temperature can be carried out. Therefore, with a lower temperature at 10^{2.5} dPa·s, a smaller burden is imposed on glass manufacturing equipment such as a melting furnace, and higher bubble quality of glass is brought about. As a result, the glass substrate can be manufactured at a lower cost. It should be noted that the temperature at 10^{2.5} dPa·s may be reduced by increasing the content of an alkali metal oxide, an alkaline earth metal oxide, ZnO, B₂O₃, or TiO₂ or decreasing the content of SiO₂ or Al₂O₃.

In the tempered glass substrate of the present invention, the liquidus temperature is preferably 1,200° C. or less, more preferably 1,050° C. or less, more preferably 1,030° C. or less, more preferably 1,010° C. or less, more preferably 1,000° C. or less, more preferably 950° C. or less, more preferably 900° C. or less, particularly preferably 870° C. or less. The liquidus temperature maybe lowered by increasing the content of Na₂O, K₂O, or B₂O₃ or reducing the content of Al₂O₃, Li₂O, MgO, ZnO, TiO₂, or ZrO₂. It should be noted that the “liquidus temperature” refers to a temperature at which crystals of glass are deposited after glass powder that passes through a standard 30-mesh sieve (sieve opening: 500 μm) and remains on a 50-mesh sieve (sieve opening: 300 μm) is placed in a platinum boat and then kept for 24 hours in a gradient heating furnace.

The liquidus viscosity is preferably 10^{4.0} dPa·s or more, more preferably 10^{4.3} dPa·s or more, more preferably 10^{4.5} dPa·s or more, more preferably 10^{5.0} dPa·s or more, more preferably 10^{5.4} dPa·s or more, more preferably 10^{5.8} dPa·s or more, more preferably 10^{6.0} dPa·s or more, particularly preferably 10^{6.2} dPa·s or more. The liquidus viscosity may be increased by increasing the content of Na₂O or K₂O or reducing the content of Al₂O₃, Li₂O, MgO, ZnO, TiO₂, or ZrO₂. It should be noted that the “liquidus viscosity” refers to a value obtained through measurement of a viscosity of glass at the liquidus temperature by a platinum sphere pull up method.

It should be noted that as the liquidus viscosity becomes higher and the liquidus temperature becomes lower, the formability as well as the devitrification resistance becomes more excellent. When the liquidus temperature is 1,200° C. or less and the liquidus viscosity is 10^{4.0} dPa·s or more, the glass substrate can be formed by an overflow down-draw method.

The tempered glass substrate of the present invention has a thermal expansion coefficient in the temperature range of from 30 to 380° C. of preferably from 70×10⁻⁷ to 110×10⁻⁷/° C., more preferably from 75×10⁻⁷ to 110×10⁻⁷/° C., more preferably from 80×10⁻⁷ to 110×10⁻⁷/° C., particularly preferably from 85×10⁻⁷ to 110×10⁻⁷/° C. When the thermal expansion coefficient falls within the range, the thermal expansion coefficient can be easily matched with that of a member such as a metal or an organic adhesive, which makes it easy to prevent the detachment of the member such as the metal or the organic adhesive. Herein, the “thermal expansion coefficient” refers to a value obtained by measuring an average thermal expansion coefficient in the temperature range of from 30 to 380° C. with a dilatometer. It should be noted that the thermal expansion coefficient maybe increased by increasing the content of an alkali metal oxide or an alkaline earth metal oxide, and conversely, may be lowered by reducing the content of the alkali metal oxide or the alkaline earth metal oxide.

The tempered glass substrate of the present invention has a Young's modulus of preferably 70 GPa or more, more preferably 73 GPa or more, particularly preferably 75 GPa or more. When the tempered glass substrate is applied to a cover glass for a display, as the Young's modulus increases, the amount of deformation upon pressing of the surface of the cover glass with a pen or a finger reduces, and hence damage to be inflicted on the internal display can be reduced.

A method of manufacturing a tempered glass substrate of the present invention comprises a step (1) of blending glass raw materials, a step (2) of melting the blended raw materials so as to comprise 1 piece/cm³ or less of devitrified stones containing Zr to obtain a molten glass, followed by forming the molten glass into a sheet shape, and a step (3) of performing ion exchange treatment to form a compressive stress layer in a glass surface, to thereby obtain a tempered glass substrate. Alternatively, a method of manufacturing a tempered glass substrate of the present invention comprises a step (1) of blending glass raw materials, a step (2)′ of melting the blended rawmaterials to obtain a molten glass, followed bybringing the molten glass into contact with a refractory comprising 10 mass % or more of Al₂O₃ to form the molten glass into a sheet shape, and a step (3) of performing ion exchange treatment to form a compressive stress layer in a glass surface, to thereby obtain a tempered glass substrate. The technical features of the method of manufacturing a tempered glass substrate of the present invention overlap with those of the tempered glass substrate of the present invention (in particular, those in the steps (1) and (3)). For the method of manufacturing a tempered glass substrate of the present invention, specific descriptions for the overlapping technical features are omitted herein.

It is preferred that the step (1) comprise a step of blending the glass raw materials so as to comprise as a glass composition, in terms of mass %, 40 to 71% of SiO₂, 3 to 30% of Al₂O₃, 0 to 3.5% of Li₂O, 7 to 20% of Na₂O, and 0 to 15% of K₂O. With this, a tempered glass having the devitrification resistance and ion exchange performance in combination can be easily produced.

In the steps (2) and (2)′, it is preferred that the blended raw materials be loaded in a continuous melting furnace, melted by heating at from 1,500 to 1,600° C., and fined, and then the molten glass be supplied to a forming apparatus and formed into a sheet shape, followed by annealing. With this, a glass substrate having high quality can be efficiently produced.

In the method of manufacturing a tempered glass substrate of the present invention, the steps (2) and (2)′ preferably comprise a step of forming the molten glass into a sheet shape by an overflow down-draw method.

The step (2) preferably comprises a step of bringing the molten glass into contact with a refractory comprising 10 mass % or more of Al₂O₃. Further, the step (2) preferably comprises a step of bringing the molten glass into contact with a refractory comprising 10 mass % or more of Al₂O₃ in the forming. With this, the devitrified stones containing Zr and further other devitrified stones can be reduced.

It is preferred that the steps (2) and (2)′ comprise a step of bringing the molten glass into contact with a refractory comprising 10 mass % or more of Al₂O₃ in the forming, the molten glass having a viscosity of 10⁴ dPa·s or more (preferably 10^{4.2} dPa·s or more, more preferably 10^{4.3} dPa·s or more, more preferably 10^{4.4} dPa·s or more, particularly preferably 10^{4.5} dPa·s or more) and 10^{5.5} dPa·s or less (preferably 10^{5.4} dPa·s or less, more preferably 10^{5.3} dPa·s or less, more preferably 10^{5.2} dPa·s or less, more preferably 10^{5.1} dPa·s or less, particularly preferably 10^{5.0} dPa·s or less). When the viscosity of the molten glass is too high in the forming, there is a risk in that a tensile stress applied to the glass becomes excessively high and the glass undergoes breakage in the forming. On the other hand, when the viscosity of the molten glass is too low in the forming, the glass is liable to deform and deterioration in quality, such as deflection or warping, is more liable to occur.

As the refractory comprising 10 mass % or more of Al₂O₃, various refractories can be used. Such refractory comprising a high content of Al₂O₃ can be produced by, for example, calcination of predetermined high-purity powder. A calcination additive may be added before the calcination as required.

From the viewpoint of compatibility with the molten glass according to the present invention, preferred examples of the refractory comprising a high content of Al₂O₃ include: a refractory disclosed in JP 2007-504088 A (a refractory comprising as a composition, in terms of mass %, 40 to 94% of Al₂O₃, 0 to 41% of ZrO₂, 2 to 22% of SiO₂, and more than 1% of Y₂O₃+V₂O₅+TiO₂+Sb₂O₃+Yb₂O₃+Na₂O); a refractory disclosed in JP 2012-020926 A (an alumina refractory, in which a tin concentration is 1 mass % or less on an oxide basis); and a refractory disclosed in US 2012/0006059 A1 (an alumina refractory, in which a tin concentration is 1 mass % or less on an oxide basis and the total content of a Ti component, a Zr component, and a Hf component is 1.5 mass % or less). Further, a refractory disclosed in WO 2012/125507 A2 (a refractory comprising at least 90 mass % of Al₂O₃ and further one kind or two or more kinds of a Ta component, a Nb component, and a Hf component); a refractory disclosed in WO 2012/135762 A2 (a refractory comprising as a composition at least 10 mass % or more of Al₂O₃, 6 mass % or less of SiO₂, and further one kind or two or more kinds of a Ti component, a Mg component a Nb component, and a Ta component); and a refractory disclosed in WO 2012/142348 A2 (a refractory comprising as a composition at least 50 mass % or more of β-Al₂O₃) are also preferred.

In the case of using a refractory comprising a high content of Al₂O₃ as the trough-shaped structure, the refractory comprising a high content of Al₂O₃ is preferably produced by cold isostatic pressing. In this case, there is preferably employed a pressure of from less than 5 kpsi (about 34 MPa) to more than 40 kpsi (about 276 MPa). Further, the trough-shaped structure has an average creep rate of preferably less than 2.5×10⁻⁷/hour at 1,180° C. and 1,000 psi, or less than 2.5×10⁻⁶/hour at 1,250° C. and 1,000 psi. This enables a longer life of the trough-shaped structure.

In the step (3), the ion exchange treatment can be carried out by, for example, immersing the glass substrate in a solution of potassium nitrate at from 400 to 550° C. for 1 to 8 hours. The conditions for the ion exchange treatment maybe optimally selected in view of, for example, the viscosity properties, applications, thickness, and internal tensile stress value of the glass.

Cutting into pieces having predetermined sizes may be carried out before the ion exchange treatment, but preferably after the ion exchange treatment in view of the manufacturing cost.

### EXAMPLE 1

The present invention is hereinafter described based on Examples. It should be noted that Examples are merely illustrative. The present invention is by no means limited to Examples.

Table 1 shows experimental samples (Sample Nos. 1 to 4) to be used for describing the present invention.

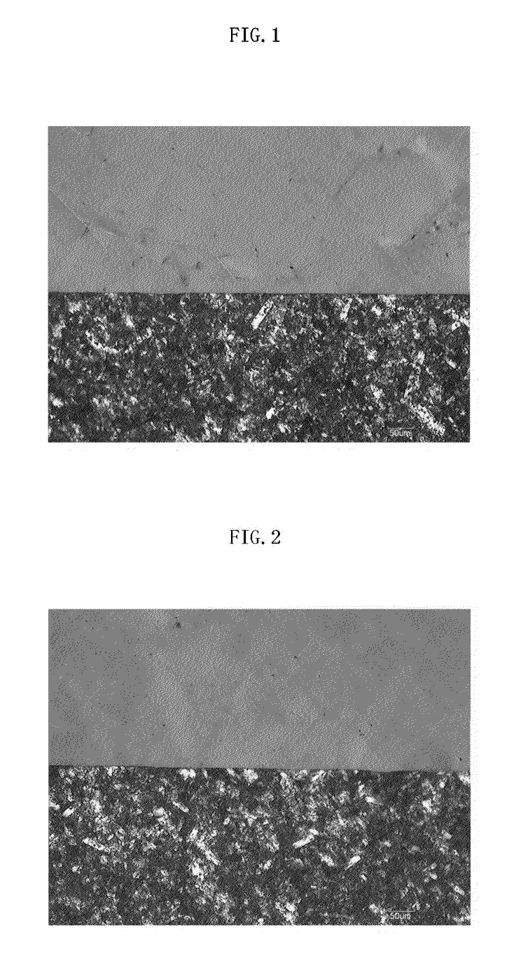

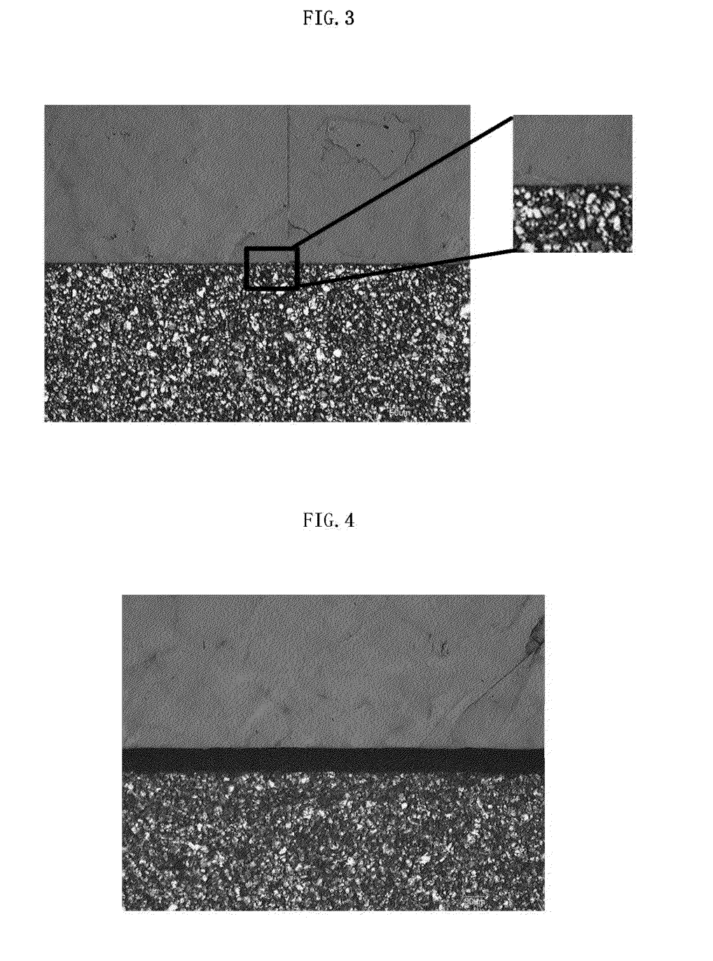

TABLE 1

| | | No. 1 | No. 2 | No. 3 | No. 4 |
|---|---|---|---|---|---|
| Glass | SiO₂ | 57.2 | 59.2 | 57.2 | 59.2 |
| composition | Al₂O₃ | 13.0 | 20.1 | 13.0 | 20.1 |
| (mass %) | B₂O₃ | 2.0 | — | 2.0 | — |
| | Li₂O | 0.1 | — | 0.1 | — |
| | Na₂O | 14.5 | 13.1 | 14.5 | 13.1 |
| | K₂O | 4.9 | 3.0 | 4.9 | 3.0 |
| | MgO | 2.0 | 1.8 | 2.0 | 1.8 |
| | CaO | 2.0 | 2.6 | 2.0 | 2.6 |
| | ZrO₂ | 4.0 | — | 4.0 | — |
| | SnO₂ | 0.3 | 0.2 | 0.3 | 0.2 |
| Density (g/cm³) | | 2.54 | 2.47 | 2.54 | 2.47 |
| Ps (° C.) | | 517 | 589 | 517 | 589 |
| Ta (° C.) | | 558 | 637 | 558 | 637 |
| Ts (° C.) | | 762 | 872 | 762 | 872 |
| 10⁴ dPa · s (° C.) | | 1,098 | 1,254 | 1,098 | 1,254 |
| 10³ dPa · s (° C.) | | 1,276 | 1,453 | 1,276 | 1,453 |
| 10^{2.5} dPa · s (° C.) | | 1,392 | 1,578 | 1,392 | 1,578 |
| TL (° C.) | | 855 | 1,020 | 855 | 1,020 |
| logη at TL (dPa · s) | | 6.2 | 5.8 | 6.2 | 5.8 |
| Thermal expansion coefficient | | 100 | 92 | 100 | 92 |
| (×10⁻⁷/° C.) | | | | | |
| Compressive stress value | | 880 | 1,020 | 880 | 1,020 |
| (MPa) | | | | | |
| Depth of layer (μm) | | 35 | 43 | 35 | 43 |
| Refractory | Devitrification | No | No | Devitrification | Devitrification |
| | | devitrification | devitrification | (FIG. 3) | (FIG. 4) |
| | | (FIG. 1) | (FIG. 2) | | |
| | Bubbling | No bubbling | No bubbling | Bubbling | Bubbling |

Each sample was produced as described below. First, glass raw materials were blended so as to have the glass composition in the table, and melted at 1,580° C. for 8 hours using a platinum pot. After that, the molten glass was poured onto a carbon sheet so as to be formed into a sheet shape. The resultant glass substrate was evaluated for various characteristics.

The density is a value obtained through measurement by a well-known Archimedes method.

The strain point Ps and the annealing point Ta are values obtained through measurement based on a method of ASTM C336.

The softening point Ts is a value obtained through measurement based on a method of ASTM C338.

The temperatures at viscosities at high temperature 10^{4.0} dPa·s, 10^{3.0} dPa·s, and 10^{2.5} dPa·s are values obtained through measurement by a platinum sphere pull up method.

The liquidus temperature TL is a value obtained through measurement of a temperature at which crystals of glass are deposited after glass powder that is obtained by pulverizing a glass, passes through a standard 30-mesh sieve (sieve opening: 500 μm), and remains on a 50-mesh sieve (sieve opening: 300 μm) is placed in a platinum boat and then kept for 24 hours in a gradient heating furnace.

The liquidus viscosity log ηTL refers to a viscosity of glass at the liquidus temperature, and is a value obtained through measurement by a platinum sphere pull up method.

The thermal expansion coefficient a is a value obtained through measurement of an average thermal expansion coefficient in the temperature range of from 30 to 380° C. using a dilatometer.

The results showed that the obtained glass substrate had a density of 2.54 g/cm³ or less and a thermal expansion coefficient of from 92×10⁻⁷ to 100×10⁻⁷/° C., and hence was suitable as a tempered glass material. In addition, the glass substrate has a liquidus viscosity of 10^{5.8} dPa·s or more, can be formed by an overflow down-draw method, and has a temperature at 10^{2.5} dPa·s of 1,578° C. or less. Accordingly, it is considered that the glass substrate can be supplied in a large amount at low cost with high productivity.

Next, both surfaces of each of the samples were subjected to optical polishing. After that, each of the samples was subjected to ion exchange treatment by being immersed in a KNO₃ molten salt at 440° C. for 6 hours. Subsequently, after washing the surfaces of each of the samples, the compressive stress values and depths of layer in the surfaces were calculated on the basis of the number of interference fringes observed using a surface stress meter (FSM-6000 manufactured by TOSHIBA CORPORATION) and intervals therebetween. In the calculation, the refractive index and optical elastic constant of each of the samples were defined as 1.52 and 28 [(nm/cm)/MPa], respectively. The results were that each of the samples had in the surface thereof a compressive stress of 500 MPa or more with its thickness of 35 μm or more. It should be noted that the glass composition in the surface layer differs microscopically between the non-tempered glass and the tempered glass, but when observed as a whole, the glass composition does not differ substantially between the glasses. That is, properties such as the density and viscosity do not differ substantially between the non-tempered glass and the tempered glass.

In addition, evaluation using a refractory was performed on Samples Nos. 1 to 4. 20 cc of each of the samples was prepared, and put in a Pt boat which was paved with rectangular column-shaped refractories of 5×12×140 mm. In this case, refractories formed mainly of alumina (90 mass % or more) were used for Samples Nos. 1 and 2 and refractories formed mainly of zircon (95 mass % or more) were used for Samples Nos. 3 and 4. Next, the Pt boats were retained at the temperature of each of the samples at 10^{4.4} dPa·s for 240 hours, and then, crystals deposited at an interface with the refractories and bubbles arising at the interface were observed. The results were that devitrification and bubbles were not observed in Sample No. 1, as shown in FIG. 1. Similarly, devitrification and bubbles were not observed in Sample No. 2, as shown in FIG. 2. In contrast, devitrification and bubbles were observed in Sample No. 3, as shown in FIG. 3. Similarly, devitrification and bubbles were observed in Sample No. 4, as shown in FIG. 4.

### EXAMPLE 2

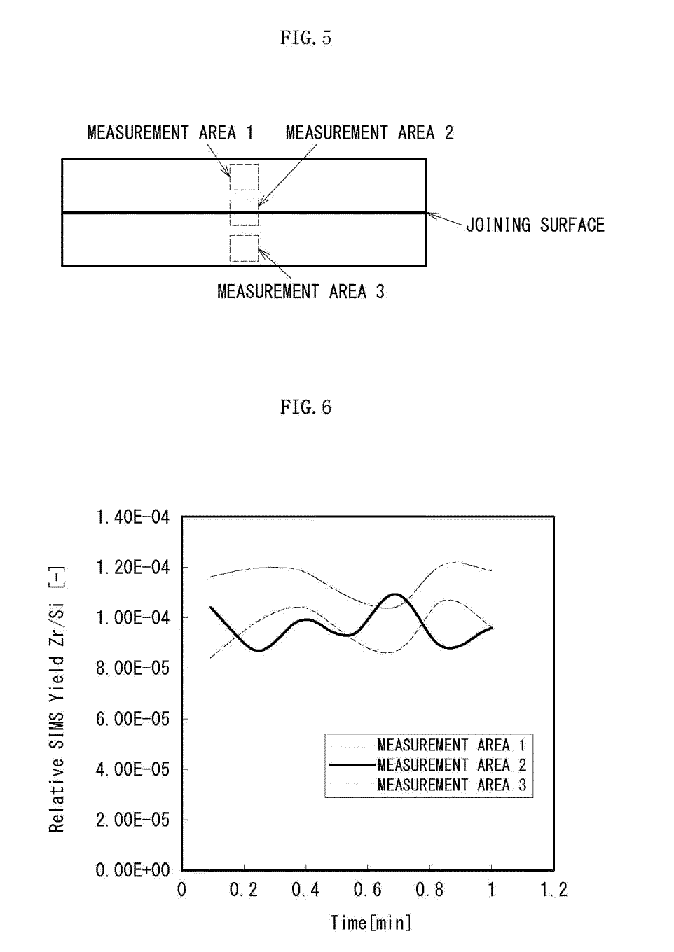

A glass sheet having a thickness of 0.7 mm was produced by an overflow down-draw method by using each of the glasses of Samples Nos. 2 and 4. In this case, a refractory formed mainly of alumina (90 mass % or more) was used as a forming trough for Sample No. 2 and a refractory formed mainly of zircon (95 mass % or more) was used as a forming trough for Sample No. 4. The content of Zr (ZrO₂) in a cross section of each of the obtained glass sheets was measured by SIMS (ATOMIKA SIMS4000). The measurement was performed for the three measurement areas illustrated in FIG. 5. Specifically, the measurement area 1 was a region with its center at 125 μm inside from the surface of the glass substrate, the measurement area 2 was a region with its center at 350 μm inside from the surface of the glass substrate (a region at the joining surface), and the measurement area 3 was a region with its center at 125 μm inside fromthe back surface of the glass substrate. The analysis conditions for SIMS were as follows: analysis element: 28Si, 90Zr; analysis size: 200 μm; acceleration energy of primary ion species: 8.0 keV; polarity of secondary ions: positive; and measurement time: 1 minute. It should be noted that the obtained Zr profile was standardized by a Si profile.

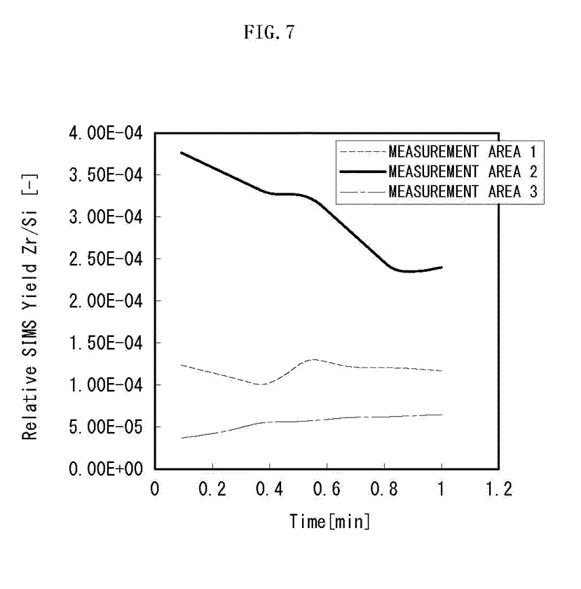

FIG. 6 shows measurement results for Sample No. 2 by SIMS and FIG. 7 shows measurement results for Sample No. 4 by SIMS. In addition, Table 2 shows measurement data of SIMS. It should be noted that S in Table 2 represents a value of measurement area 2/((measurement area 1+measurement area 3)/2). The results showed that the content of Zr (ZrO₂) in the joining surface was low in Sample No. 2. On the other hand, the content of Zr (ZrO₂) in the joining surface was high in Sample No. 4.

TABLE 2

| | No. 2 | | | No. 4 | | |
|---|---|---|---|---|---|---|
| | Mea- | Mea- | Mea- | Mea- | Mea- | Mea- |
| | sure- | sure- | sure- | sure- | sure- | sure- |
| Time | ment | ment | ment | ment | ment | ment |
| [min] | area 1 | area 2 | area 3 | area 1 | area 2 | area 3 |
| 0.1 | 0.00008 | 0.00010 | 0.00012 | 0.00012 | 0.00038 | 0.00004 |
| 0.2 | 0.00010 | 0.00009 | 0.00012 | 0.00011 | 0.00035 | 0.00004 |
| 0.4 | 0.00010 | 0.00010 | 0.00012 | 0.00010 | 0.00033 | 0.00006 |
| 0.5 | 0.00009 | 0.00009 | 0.00011 | 0.00013 | 0.00032 | 0.00006 |
| 0.7 | 0.00009 | 0.00011 | 0.00010 | 0.00012 | 0.00028 | 0.00006 |
| 0.8 | 0.00011 | 0.00009 | 0.00012 | 0.00012 | 0.00024 | 0.00006 |
| 1.0 | 0.00010 | 0.00010 | 0.00012 | 0.00012 | 0.00024 | 0.00006 |
| Average | 0.00010 | 0.00010 | 0.00012 | 0.00012 | 0.00031 | 0.00005 |

| | | |
|---|---|---|
| S | 0.92 | 3.55 |

Sample No. 2 was observed with a stereoscopic microscope. In the observation, the number of the devitrified stones containing Zr (size: 1 μm or more) was counted and converted into an incidence per 1 cm³. The result was that the incidence was 0.01 piece/cm³ or less.

### INDUSTRIAL APPLICABILITY

The tempered glass of the present invention is suitable for a cover glass for a cellular phone, a digital camera, a PDA, a solar cell, or the like, or a substrate for a touch panel display. Further, the tempered glass of the present invention can be expected to find use in applications requiring high mechanical strength, for example, a window glass, a substrate for a magnetic disk, a substrate for a flat panel display, a cover glass for a solid image pick-up element, and tableware, in addition to the above-mentioned applications.

1. A tempered glass substrate having a compressive stress layer in a surface thereof, the tempered glass substrate comprising 1 piece/cm³ or less of devitrified stones containing Zr.

2. The tempered glass substrate according to claim 1, wherein the tempered glass substrate has the compressive stress layer in a surface of a glass substrate formed by an overflow down-draw method.

3. A tempered glass substrate, having a value of (a content of Zr in a center portion in a thickness direction)/(a content of Zr near a surface) of 3 or less.

4. The tempered glass substrate according to claim 1, wherein the compressive stress layer is formed by chemical treatment.

5. The tempered glass substrate according to claim 1, wherein the tempered glass substrate has a compressive stress value in a surface of 300 MPa or more, a depth of layer of 10 μm or more, and an internal tensile stress value of 200 MPa or less.

6. The tempered glass substrate according to claim 1, wherein the tempered glass substrate has an unpolished surface.

7. The tempered glass substrate according to claim 1, wherein the tempered glass comprises as a glass composition, in terms of mass %, 40 to 71% of Sio₂, 3 to 30% of Al₂O₃, 0 to 3.5% of Li₂O, 7 to 20% of Na₂O, and 0 to 15% of K₂O.

8. The tempered glass substrate according to claim 1, wherein the tempered glass comprises as a glass composition, in terms of mass %, 40 to 71% of SiO₂, 7.5 to 30% of Al₂O₃, 0 to 2% of Li₂O, 10 to 19% of Na₂O, 0 to 15% of K₂O, 0 to 6% of MgO, 0 to 6% of CaO, 0 to 3% of SrO, 0 to 3% of BaO, and 0 to 8% of ZnO.

9. The tempered glass substrate according to claim 1, wherein the tempered glass substrate is used for a cover glass for a display.

10. The tempered glass substrate according to claim 1, wherein the tempered glass substrate is used for a cover glass for a solar cell.

11. A method of manufacturing a tempered glass substrate, the method comprising:
a step (1) of blending glass raw materials;
a step (2) of melting the blended raw materials so as to comprise 1 piece/cm³ or less of devitrified stones containing Zr to obtain a molten glass, followed by forming the molten glass into a sheet shape; and
a step (3) of performing ion exchange treatment to form a compressive stress layer in a glass surface, to thereby obtain a tempered glass substrate.

12. The method of manufacturing a tempered glass substrate according to claim 11, wherein the step (1) comprises a step of blending the glass raw materials so as to comprise as a glass composition, in terms of mass %, 40 to 71% of SiO₂, 3 to 30% of Al₂O₃, 0 to 3.5% of Li₂O, 7 to 20% of Na₂O, and 0 to 15% of K₂O.

13. The method of manufacturing a tempered glass substrate according to claim 11, wherein the step (2) comprises a step of forming the molten glass into a sheet shape by an overflow down-draw method.

14. The method of manufacturing a tempered glass substrate according to claim 11, wherein the step (2) comprises a step of bringing the molten glass into contact with a refractory comprising 10 mass % or more of Al₂O₃.

15. The method of manufacturing a tempered glass substrate according to claim 11, wherein the step (2) comprises a step of bringing the molten glass into contact with a refractory comprising 10 mass % or more of Al₂O₃ in the forming.

16. The method of manufacturing a tempered glass substrate according to claim 11, wherein the step (2) comprises a step of bringing the molten glass into contact with a refractory comprising 10 mass % or more of Al₂O₃ in the forming, the molten glass having a viscosity of 10⁴ dPa·s or more and 10⁵ dPa·s or less.

17. A method of manufacturing a tempered glass substrate, the method comprising:
a step (1) of blending glass raw materials;
a step (2)′ of melting the blended raw materials to obtain a molten glass, followed by bringing the molten glass into contact with a refractory comprising 10 mass % or more of Al₂O₃ to form the molten glass into a sheet shape; and
a step (3) of performing ion exchange treatment to form a compressive stress layer in a glass surface, to thereby obtain a tempered glass substrate.

18. The tempered glass substrate according to claim 2, wherein the compressive stress layer is formed by chemical treatment.

19. The tempered glass substrate according to claim 2, wherein the tempered glass substrate has a compressive stress value in a surface of 300 MPa or more, a depth of layer of 10 μm or more, and an internal tensile stress value of 200 MPa or less.

20. The tempered glass substrate according to claim 2, wherein the tempered glass substrate has an unpolished surface.

21. The tempered glass substrate according to claim 2, wherein the tempered glass comprises as a glass composition, in terms of mass %, 40 to 71% of SiO₂, 3 to 30% of Al₂O₃, 0 to 3.5% of Li₂O, 7 to 20% of Na₂O, and 0 to 15% of K₂O.

22. The tempered glass substrate according to claim 2, wherein the tempered glass comprises as a glass composition, in terms of mass %, 40 to 71% of SiO₂, 7.5 to 30% of Al₂O₃, 0 to 2% of Li₂O, 10 to 19% of Na₂O, 0 to 15% of K₂O, 0 to 6% of MgO, 0 to 6% of CaO, 0 to 3% of SrO, 0 to 3% of BaO, and 0 to 8% of ZnO.

23. The tempered glass substrate according to claim 2, wherein the tempered glass substrate is used for a cover glass for a display.

24. The tempered glass substrate according to claim 2, wherein the tempered glass substrate is used for a cover glass for a solar cell.

25. The tempered glass substrate according to claim 3, wherein the compressive stress layer is formed by chemical treatment.

26. The tempered glass substrate according to claim 3, wherein the tempered glass substrate has a compressive stress value in a surface of 300 MPa or more, a depth of layer of 10 μm or more, and an internal tensile stress value of 200 MPa or less.

27. The tempered glass substrate according to claim 3, wherein the tempered glass substrate has an unpolished surface.

28. The tempered glass substrate according to claim 3, wherein the tempered glass comprises as a glass composition, in terms of mass %, 40 to 71% of SiO₂, 3 to 30% of Al₂O₃, 0 to 3.5% of Li₂O, 7 to 20% of Na₂O, and 0 to 15% of K₂O.

29. The tempered glass substrate according to claim 3, wherein the tempered glass comprises as a glass composition, in terms of mass %, 40 to 71% of SiO₂, 7.5 to 30% of Al₂O₃, 0 to 2% of Li₂O, 10 to 19% of Na₂O, 0 to 15% of K₂O, 0 to 6% of MgO, 0 to 6% of CaO, 0 to 3% of SrO, 0 to 3% of BaO, and 0 to 8% of ZnO.

30. The tempered glass substrate according to claim 3, wherein the tempered glass substrate is used for a cover glass for a display.

31. The tempered glass substrate according to claim 3, wherein the tempered glass substrate is used for a cover glass for a solar cell.
